(19) United States
(12) Patent Application Publication
(10) Pub. No.: US 2002/0140836 A1
(43) Pub. Date: Oct. 3, 2002

(54) Imaging device and manufacturing method thereof

(75) Inventors: Hiroyuki Miyake, Chiyoda-ku (JP); Noriyuki Komori, Chiyoda-ku (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Chiyoda-ku (JP)

(21) Appl. No.: 10/106,193

(22) Filed: Mar. 27, 2002

(30) Foreign Application Priority Data
Mar. 28, 2001 (JP) 2001-093815

(51) Int. Cl. H04N 5/225

(52) U.S. Cl. 348/340

(57) ABSTRACT

An imaging device including an imaging element having a light acceptance plane, a circuit board for the imaging element, a frame member for supporting the imaging element, and a supporting member for supporting an image formation lens. Further, the frame member surrounds and fixedly supports the imaging element so that an imaging element plane on a side of the light acceptance plane and a reference plane of the frame member are located on a same plane or have a predetermined difference in relative distance. In addition, the reference plane of the frame member and the reference plane of the supporting member for supporting the image formation lens are brought into contact with each other so as to be integrated.

### CROSS-REFERENCE TO A RELATED APPLICATION

The present patent application is related to the Attorney Docket No. 220005US-2 filed on Mar. 27, 2002, by the Applicant (corresponding to the Japanese Patent Application No. 2001-098799 filed on Mar. 30, 2001).

### BACKGROUND OF THE INVENTION

1. Field of the Invention

The present invention relates to an imaging device used in hand-held terminals such as cellular phones, PDA (photo-detector array), and electronic devices such as personal computers, video cameras, scanners, etc. The present invention also relates to a manufacturing method of the imaging device.

2. Background Art

Imaging devices are widely used in hand-held terminals of cellular phones and the like under the background of recent progress of communication technology. These imaging devices are increasingly required to be more compact, and various technological developments have been attempted to reduce the size of the devices.

For example, FIG. 21 is a sectional view showing an imaging device according to prior art disclosed in Japanese Patent Publication (unexamined) No. 112854/1999. As shown, an imaging element 1 has a light acceptance plane 2. Also included is a peripheral circuit element 3. These elements are mounted on a circuit board 4. Further, an accommodating vessel 5 accommodates the circuit board 4 with the imaging element 1 and the peripheral circuit element 3, and a lens holder 6 holds a lens 7. Also shown is an optical diaphragm 8. A peripheral frame portion of the lens holder 6 includes a protrusion 6a and a bottom portion 6b arranged to form a step.

Further, a peripheral frame portion of the accommodating vessel 5 includes a bottom portion 5a and a protrusion 5b also arranged to form a step.

The protrusion portion 6a inside of the lens holder 6 and the bottom portion 5a inside of the accommodating vessel 5 form an optical positioning reference plane for optically positioning the device. Accordingly, when the lens holder 6 and the accommodating vessel 5 are combined with each other, the protrusion 6a and the bottom portion 5a of the accommodating vessel 5 are brought into contact with each other. In addition, a clearance exists between the bottom portion 6b and the protrusion portion 5b, which is used to glue the parts together. In this manner, an optical axis is prevented from deviation due to an insufficient application of adhesive.

In the above-mentioned imaging device according to the prior art, however, a problem exists because the distance between the light acceptance plane 2 and the lens 7 is positioned at a predetermined focal distance even if the deviation of optical axis is corrected. More specifically, dispersion just in the aspect of thickness of the imaging element 1 mounts to several 10 μm. There may be further dispersion in the thickness of the circuit board 4 and in the thickness due to adherence between the imaging element 1 and circuit board 4, as well as between the circuit board 4 and the accommodating vessel 5. Considering the foregoing dispersion, a problem exists because the distance between the light acceptance plane 2 and the lens 7 is accurately located at a predetermined focal distance. This problem becomes more serious as the imaging device becomes more compact.

Another problem exists because when the imaging element 1 is mounted on the circuit board and the accommodating vessel has a large thickness, the height of the device increases.

### SUMMARY OF THE INVENTION

Accordingly, one object of the present invention is to solve the above-discussed and other problems.

Another object of the present invention is to provide a high quality imaging device in which the distance between the light acceptance plane of the imaging element and the lens can be located at a predetermined focal distance

Yet another object of the present invention is to provide a manufacturing method of the imaging device.

To achieve these and other objects, the present invention provides a novel imaging device including an imaging element having a light acceptance plane, a circuit board for the imaging element, a frame member for supporting the imaging element, and a supporting member for supporting an image formation lens. Further, the frame member surrounds and fixedly supports the imaging element so that an imaging element plane on a side of the light acceptance plane and a reference plane of the frame member are located on a same plane or have a predetermined difference in relative distance. Also, the reference plane of the frame member and the reference plane of the supporting member for supporting the image formation lens are brought into contact with each other so as to be integrated.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows an imaging device according to Embodiment 1 of the present invention, and is a sectional view taken along the line I-I in FIG. 2;

FIG. 2 is a perspective view of the imaging device according to Embodiment 1;

FIG. 3 is an exploded perspective view of a part of the imaging device showing a manufacturing method according to Embodiment 1;

FIG. 4 is an exploded perspective view showing the manufacturing method;

FIG. 5 is a sectional view showing the manufacturing method;

FIG. 6 is a sectional view showing the imaging device according to Embodiment 2 of the present invention;

FIG. 7 is a sectional view of a part of the imaging device showing a manufacturing process according to Embodiment 3 of the present invention;

FIG. 8 is a sectional view of a part of the imaging device showing a manufacturing process according to Embodiment 4 of the present invention;

FIG. 9 is a sectional view of a part of the imaging device showing a manufacturing process according to Embodiment 5 of the present invention;

FIG. 10 is a sectional view of a part of the imaging device showing a manufacturing process according to Embodiment 6 of the present invention;

FIG. 11 is a sectional view of a part of the imaging device showing a manufacturing process according to Embodiment 6 of the present invention;

FIG. 12 is a sectional view of a part of the imaging device showing a manufacturing process according to Embodiment 7 of the present invention;

FIG. 13 is an exploded perspective view under the manufacturing process of the imaging device according to Embodiment 8 of the present invention;

FIG. 14 is a perspective view of a completed imaging device according to Embodiment 8;

FIG. 15 is a sectional view of a part of the imaging device under the manufacturing process according to Embodiment 8;

FIG. 16 is a sectional view of a part of the imaging device under the manufacturing process according to Embodiment 9 of the present invention;

FIG. 17 is a sectional view of a part of the imaging device under the manufacturing process according to Embodiment 10 of the present invention;

FIG. 18 is an exploded perspective view of the imaging device under the manufacturing process according to Embodiment 10;

FIG. 19 is a sectional view of the imaging device according to Embodiment 10;

FIG. 20 is a perspective view of a completed imaging device according to Embodiment 10; and

FIG. 21 is a sectional view of the imaging device according to the prior art.

### DESCRIPTION OF THE PREFERRED EMBODIMENTS

Referring now to the drawings, wherein like reference numerals designate identical or corresponding parts throughout the several views, the present invention will be described.

Embodiment 1.

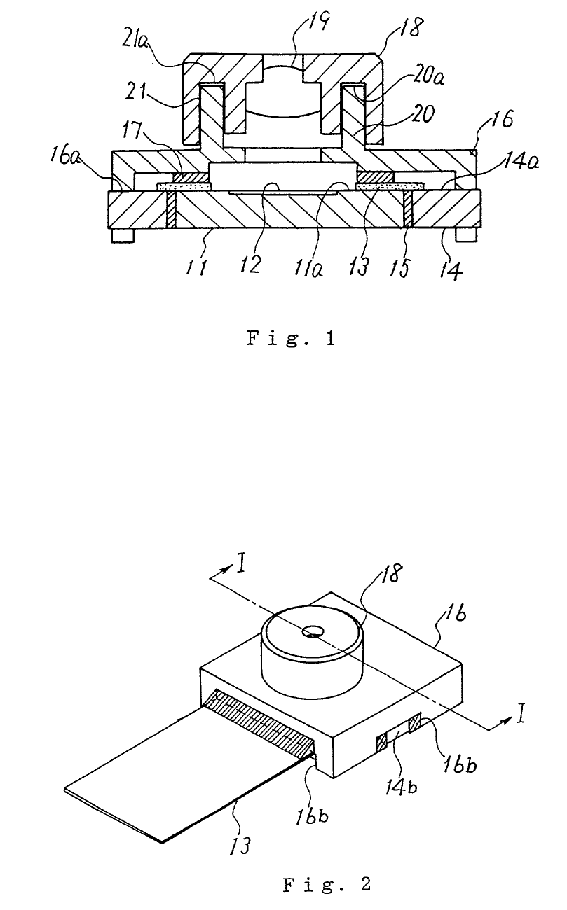

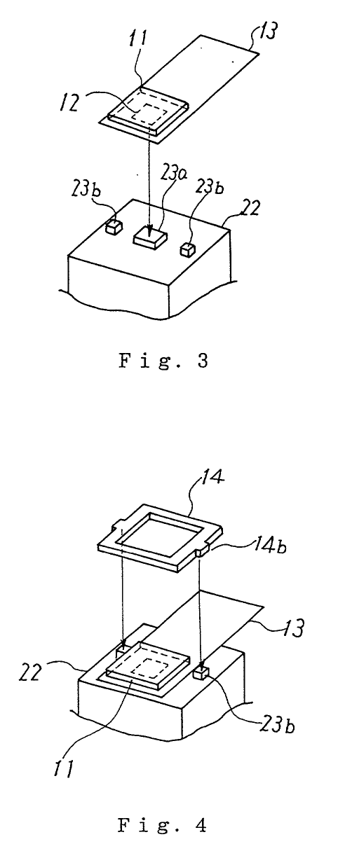

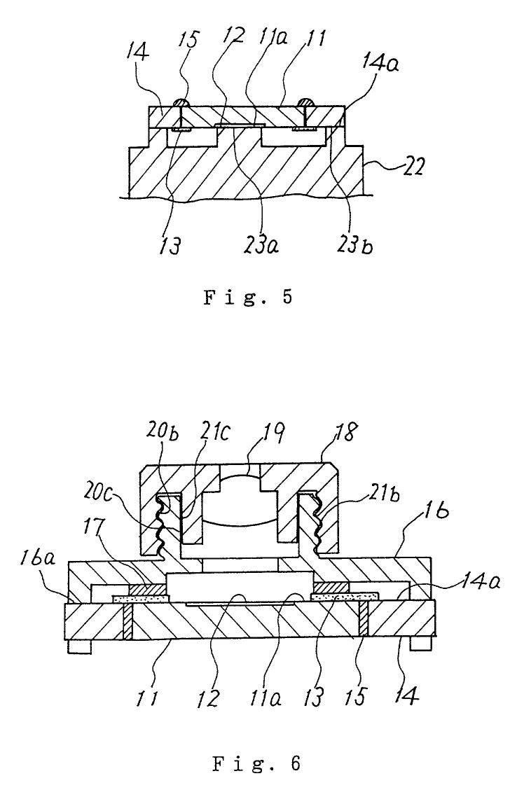

FIG. 1 shows an imaging device according to Embodiment 1 of the present invention as a sectional view taken along the line I-I in FIG. 2, and FIG. 2 is a perspective view of the imaging device according to Embodiment 1. Further, FIG. 3 is an exploded perspective view showing a manufacturing method of the imaging device according to Embodiment 1, FIG. 4 is an exploded perspective view showing the manufacturing method, and FIG. 5 is a sectional view of the manufacturing method showing a manufacturing process subsequent to FIG. 4.

As shown, an imaging element 11 has a light acceptance plane 12 on the imaging element plane opposite to an image formation lens. Also shown is a film-like circuit board 13 to which the imaging element 11 is glued by connecting a terminal thereof to wiring of the circuit board. In addition, a peripheral circuit element including a semiconductor chip, a capacitor and a register are packaged in the film-like circuit board 13, though not illustrated.

Further, a frame member 14 surrounds the square imaging element 11 fixedly with an adhesive 15 in such a manner that a reference plane 14a of the frame member 14 and a reference plane 11a of the imaging element 11 on the light acceptance plane 12 are on the same plane. A supporting member 16 having a reference plane 16a and the reference plane 14a of the frame member 14 are brought into contact with each other, and the frame member 14 having the imaging element 11 and the supporting member 16 is integrated by applying an adhesive.

In addition, a cylindrical lens holder 18 fixedly holds an image formation lens 19 at one end. The cylindrical lens holder 18 is supported on the supporting member 16 by fitting a cylindrical protrusion 20 of the supporting member 16 into a cylindrical recess 21 of the lens holder 18. A reference plane 20a of the cylindrical protrusion 20 and a reference plane 21a of the cylindrical recess 21 are brought into contact with each other so as to be fully fitted. As a result, the image formation lens 19 can be located at a predetermined focal distance with respect to the light acceptance plane 12 of the imaging element 11.

Thus, positioning in a longitudinal direction can be achieved with high accuracy, and positioning in a transverse direction (an optical axis of the image formation lens) is regulated with high accuracy by fitting the cylindrical protrusion 20 and the cylindrical recess 21. In addition, the frame member 14, the supporting member 16 and the lens holder 18 are molded of plastic such as polycarbonate. Liquid photo-reactive adhesive, ultra-violet-setting adhesive and natural-setting instantaneous adhesive and the like may be used as the adhesive.

FIGS. 3, 4 and 5 show the former stage of the manufacturing process of the imaging device in order. As shown, an assembling stage includes supporting protrusions 23a and 23b. Upper end faces of the supporting protrusions 23a and 23b are flush and serve as the reference plane. The reference plane 11a on the light acceptance plane 12 side glued to the circuit board 13 is positioned on the reference plane of the supporting protrusion 23a and brought into contact with the reference plane (see FIGS. 3 and 4). Subsequently, the frame member 14 is positioned so as to surround the imaging element 11, and the reference plane 14a of the frame member 14 is brought into contact with the reference plane of the supporting protrusion 23b. Further, as shown, the frame member 14 includes a projection 14b.

Referring to FIG. 5, the reference plane 11a of the imaging element 11 and the reference plane of the supporting protrusion 23a, and the reference plane 14a of the frame member 14 and the reference plane of the supporting protrusion 23b are respectively brought into contact with each other. Applying a load from above in the drawing holds these reference planes in place. Subsequently, an adhesive 15 is applied from the opposite side of the light acceptance plane of the imaging element 11, whereby the imaging element 11 and the frame member 14 are fixedly glued to each other and integrated.

At this time, a tensile force is applied as the adhesive sets. Therefore, by applying a load larger than the tensile force, the reference plane 11a and the reference plane 14a of the frame member 14 are maintained in the same plane, thus completing the adhesion step.

Next, the frame member 14 having the imaging element 1 integrated therewith is turned upside down, and as shown in FIG. 1, the reference plane 14a of the frame member 14 and the reference plane 16a of the supporting member 16 are brought into contact with each other and positioned. Holding this positioned state, the reference planes are integrated by applying the adhesive 17. The adhesive 17 is further applied to a portion between the projection 14b of the frame member 14 and a recess of the supporting member 16, and to a portion between the circuit board 13 and a recess of the supporting member 16 for fixing them. The remaining process is as described with reference to FIG. 1.

In the above-constructed imaging device, contact is established between the reference planes 11a and 14a, as well as between the reference planes 14a and 16a on the same plane. Contact is also established between the reference planes 20a and 21a. Therefore, the image formation lens 19 is positioned at a predetermined focal distance with high accuracy with respect to the light acceptance plane 12, thereby improving the longitudinal positioning accuracy.

Further, the imaging device according to Embodiment 1 is compact in the longitudinal direction. More specifically, an overlap exists in the longitudinal direction between the film-like circuit board 13 and the imaging element 11. However, because the circuit board 13 is film-like, the overlap is very little, and the frame member 14 substantially supports the imaging element 11. Thus, there is no overlap in the longitudinal direction between the imaging element 11 and the frame member 14. Furthermore, because the imaging element 11 and the frame member 14 are glued together on the opposite side of the light acceptance plane, the adhesive 15 is not squeezed out, and the adhesive 15 does not stick to the light acceptance plane 12.

Embodiment 2.

Turning now to FIG. 6, which is a sectional view showing an imaging device according to Embodiment 2 of the present invention. In this embodiment, a threaded (male screw) portion 20b of the cylindrical protrusion 20, and a threaded (female screw) portion 21b of the cylindrical recess 21 is provided. By providing the portions 20b, 21b and screwing them together, it is possible to further delicately adjust the predetermined focal distance of the image formation lens 19 with respect to the light acceptance plane 12. In addition, the positioning in a transverse direction (an optical axis of the image formation lens) is regulated with high accuracy by a fitting contact face 20c of the supporting member 16 and a fitting contact face 21c of the lens holder 18.

Embodiment 3.

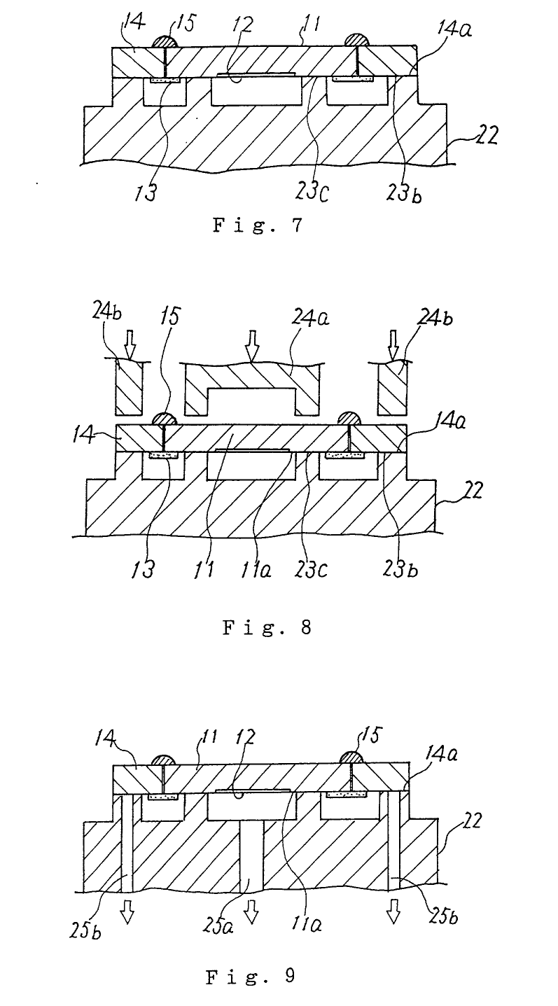

Next, FIG. 7 is a sectional view of a part of the imaging device showing a manufacturing process according to Embodiment 3 of the present invention. The supporting protrusion 23a shown in FIG. 5 according to the foregoing Embodiment 1 of the invention is directly in contact with the light acceptance plane 12 of the imaging element 11. On the other hand, a supporting protrusion 23c in FIG. 7 is in contact with the face of the imaging element 11 outside of the light acceptance plane 12. As a result, the light acceptance plane 12 is not damaged due to a direct contact of the supporting protrusion 23a with the light acceptance plane 12.

Embodiment 4.

FIG. 8 is a sectional view of a part of the imaging device showing a manufacturing process according to Embodiment 4 of the present invention, and in which a load is applied to the imaging element 11 and the frame member 14 when they are glued together. As shown, pressing tools 24a, 24b are configured to apply a load to the position opposite the supporting protrusions 23b, 23c. By applying a load using the pressing tools 24a, 24b, the reference plane 11a of the imaging element 11 and the reference plane 14a of the frame member 14 are forced to keep the same plane, and the adhesion step is completed.

Embodiment 5.

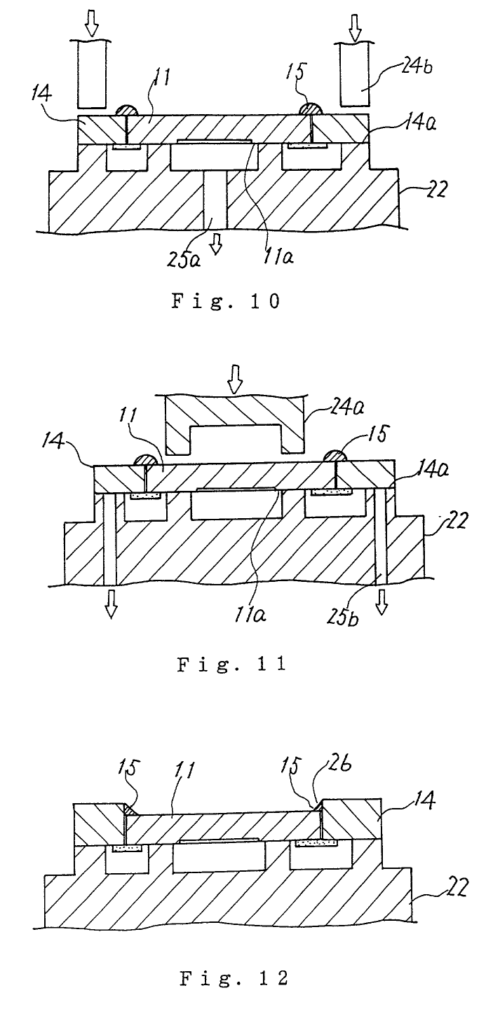

Next, FIG. 9 is a sectional view of a part of the imaging device showing a manufacturing process according to Embodiment 5 of the present invention, and in which the imaging element 11 and the frame member 14 are held by vacuum suction when they are glued together. As shown, the stage 22 includes suction ports 25a, 25b. The suction port 25a functions (draws in) on the image element 11, and the suction port 25b functions (draws in) on the frame member 14. With such vacuum suction by the suction ports 25a, 25b, the reference plane 11a of the imaging element 11 and the reference plane 14a of the frame member 14 are forced to keep the same plane, and the adhesion step is completed.

Embodiment 6.

FIGS. 10 and 11 are sectional views of a part of the imaging device respectively showing a manufacturing process according to Embodiment 6 of the present invention. In this embodiment, the imaging element 11 and the frame member 14 are held by vacuum suction while a load is applied thereto when the parts are glued together. The reference plane 11a of the imaging element 11 and the reference plane 14a of the frame member 14 are forced to keep the same plane by the application of load and by vacuum suction. As a result, the delicate imaging element is further stabilized, and the adhesion step is completed.

Embodiment 7.

Next, FIG. 12 is a sectional view showing an imaging device according to Embodiment 7 of the invention. In this embodiment, the frame member 14 is thicker than the imaging element 11, a level difference is provided at the contact position between them, and the adhesive is applied to the corner 26 formed by such level difference so as to adhere the parts together. In this manner, it is possible to prevent unnecessary dispersion of the adhesive, and furthermore any adhesive having a low viscosity can be used.

Embodiment 8.

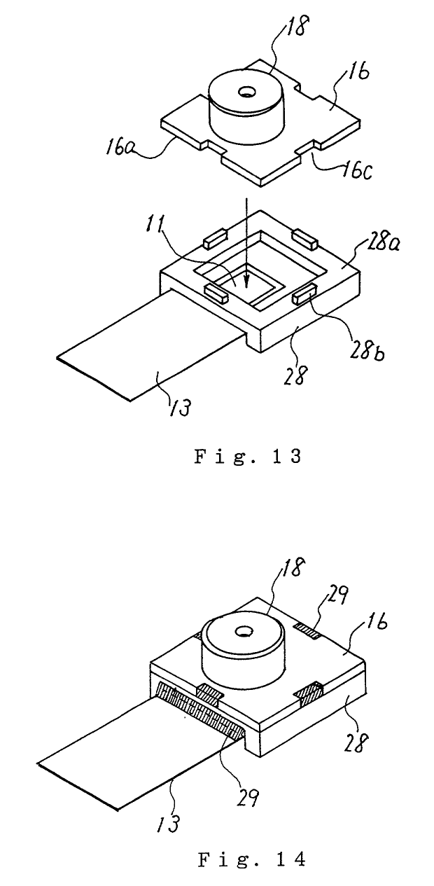

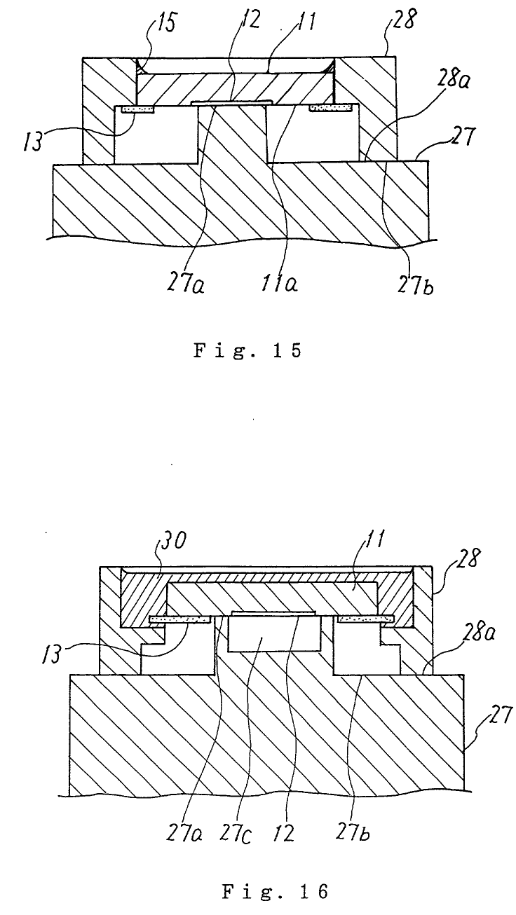

FIG. 13 is an exploded perspective view under the manufacturing process of the imaging device according to Embodiment 8 of the present invention, FIG. 14 is a perspective view of a completed imaging device according to Embodiment 8, and FIG. 15 is a sectional view of a part of the imaging device under the manufacturing process according to Embodiment 8.

As shown in FIG. 15, an assembling stage 27 has a first reference plane 27a and a second reference plane 27b with a level difference therebetween. The reference plane 11a of the imaging element 1 on the side of the light acceptance plane 2 is brought into contact with the first reference plane 27a and placed thereon. A square frame member 28 is positioned so as to surround the imaging element 11, and a reference plane 28a of the square frame member 28 is brought into contact with the second reference plane 27b of the stage 27 and held there. As a result, the plane 11a of the imaging element 11 on the side of the light acceptance plane 12 and the reference plane 28a of the frame member 28 can be maintained to have a predetermined difference in relative distance. Maintaining such a contact state, a load is then applied to the imaging element 11 and the frame member 28 so as to hold them together, whereby the imaging element 11 and the frame member 28 are fixedly glued to each other and integrated.

As shown in FIG. 13, the imaging element 11 and the frame member 28 integrated into a single unit is provided with projections 28b to regulate the positioning at the four corners of the reference plane 28a respectively. A supporting member 16 supports the lens holder 18 having an image formation lens thereon, and of which the lower part is a flat plate and the bottom face serves as a reference plane 16a. As shown, the flat plate on the lower part has recesses (cutout parts) 16c respectively at the four corners.

Referring again to FIG. 13, the supporting member 16 is moved in the direction indicated by the arrow, and the projections 28b of the frame member 28 are fitted into the recesses 16c of the supporting member 16 so as to position the parts together. At the same time, the reference plane 28a of the frame member 28 and the reference plane 16a of the supporting member 16 are brought into contact with each other. By holding such a contact state while applying the load, the frame member 28 and the supporting member 16 are glued and integrated into a single unit.

Next, FIG. 14 shows an assembled imaging device including glued portions 29. In the above-constructed imaging device, the reference plane 11a of the imaging element 11 on the side of the light acceptance plane 12 and the reference plane 28a of the frame member 28 are fixedly supported with a predetermined difference in relative distance. Such fixation and support are achieved by the direct contact between the reference planes 28a, 16a. As a result, the image formation lens 19 can be located at a predetermined focal distance with respect to the light acceptance plane with high accuracy.

Embodiment 9.

Next, FIG. 16 is a sectional view of a part of the imaging device under the manufacturing process according to Embodiment 9 of the present invention, and shows a modification of the construction shown in FIG. 15. The difference from FIG. 15 will now be described. The first reference plane 27a of the assembling stage 27 includes a recess 27c at the central portion. Thus, the imaging element 11 does not come in contact with the light acceptance plane 12 when mounted, and the light acceptance plane 12 is prevented from being damaged.

Further, an adhesive 12 is used for integrally gluing the imaging element 11 and the frame member 28, and the glued portion is sealed with the adhesive. It is also preferable the construction shown in FIG. 16 is used, instead of that shown in FIG. 15, to form the construction shown in FIGS. 13 and 14.

Embodiment 10.

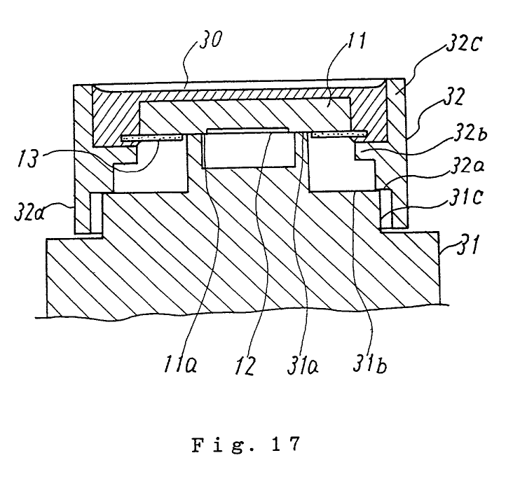

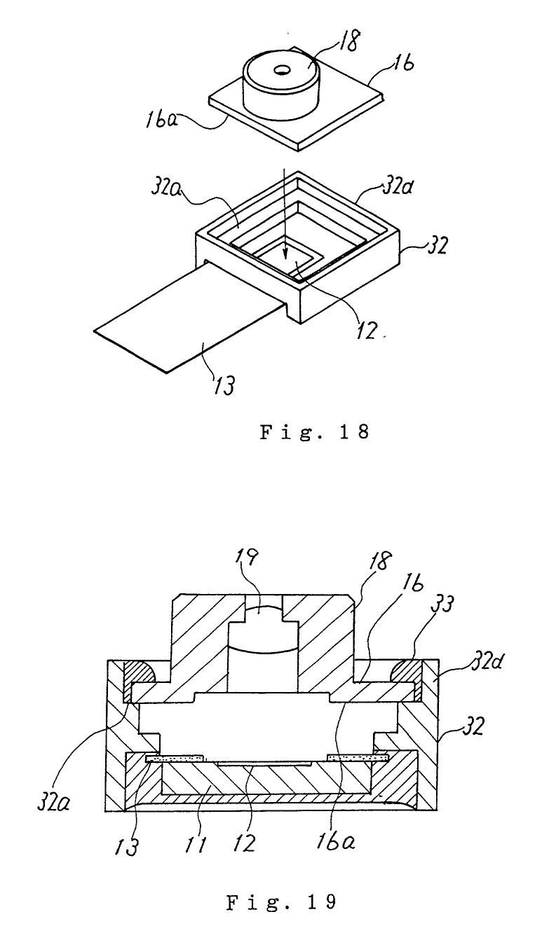

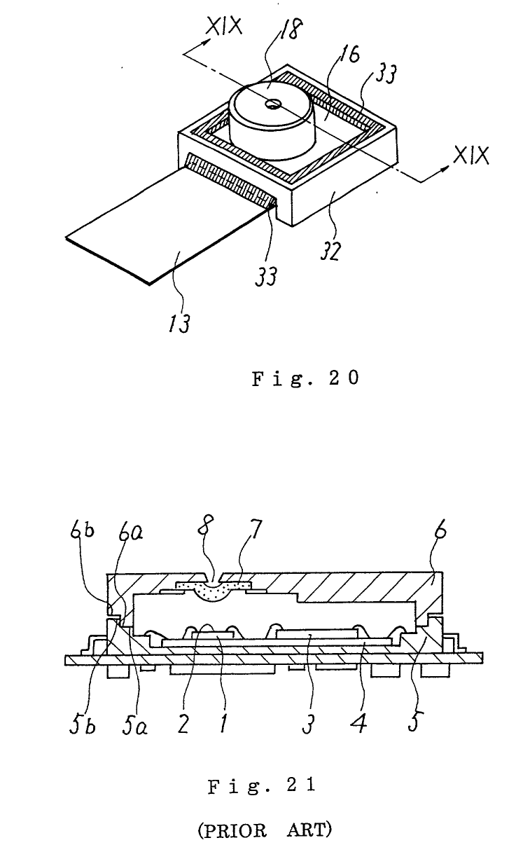

FIG. 17 is a sectional view of a part of the imaging device under the manufacturing process according to Embodiment 10 of the present invention, and FIG. 18 is an exploded perspective view of the imaging device under the manufacturing process according to Embodiment 10. Further, FIG. 19 shows the imaging device according to Embodiment 10 and is a sectional view taken along the line XIX-XIX, and FIG. 20 is a perspective view of the imaging device according to Embodiment 10.

In FIG. 17, an assembling stage 17 has a first reference plane 31a and a second reference plane 31b with a level difference therebetween, and also includes an annular notch 31c. In addition, a square frame member 32 includes plural level differences inside, and a reference plane 32a is brought into contact with the second reference plane 31b for positioning. Also shown is a wall portion 32d of the frame member 32. Further, the reference plane 11a of the imaging element 11 on the side of the light acceptance plane 12 is brought into contact with the first reference plane 31a for positioning. As a result, the level difference portion 32b and the peripheral wall 32c of the frame member 32 surround the imaging element 11.

Maintaining such a state, a load is then applied to the imaging element 11 and the frame member 32, and they are glued and sealed with the adhesive 30. As a result, the reference plane 11a of the imaging element 11 on the side of the light acceptance plane 12 and the reference plane 32a of the frame member 32 are glued and sealed with a predetermined difference in relative distance. Thus, the imaging element 11 and the frame member 32 are integrated.

When the frame member 32 having the imaging element 11 integrated therewith is removed from the stage and turned upside down, a component as shown in the lower part of FIG. 18 is obtained. As shown, the wall portion 32d surrounds the reference plane 32a of the frame member 32, and the reference plane 32a and the wall portion 32d form a cavity. A supporting member 16 supports the lens holder 18 having an image formation lens thereon, and of which a lower part is a flat plate and a bottom face serves as a reference plane 16a.

Referring again to FIG. 18, the supporting member 16 is moved in the direction indicated by the arrow, and is fitted into the cavity 16c of the frame member 32. At the same time, the reference plane 32a and the reference plane 16a are brought into contact with each other and held while a load is applied. As shown in FIG. 19, a height of the wall portion 32d is larger than a thickness of the flat plate of the supporting member 16. Therefore, a level difference is formed between the flat plate of the supporting member 16 and the wall portion 32d. By applying an adhesive 33 to the square level difference portion, the frame member 32 and the supporting member 16 are glued and integrated into a single unit. FIG. 20 shows such an integrally assembled imaging device.

Further, in the Embodiment 10, the imaging element 11 and the frame member 32 are integrated so the reference plane 11a on the side of the light acceptance plane 12 and the reference plane 32a maintain a predetermined difference in relative distance. By using the lens holder 18 and the supporting member 16 preliminarily combined with each other, the number of components can be reduced. Furthermore, in the Embodiment 10, the image formation lens 19 is positioned at a predetermined focal distance with respect to the light acceptance plane 12.

Obviously, numerous modifications and variations of the present invention are possible in light of the above teachings. It is therefore to be understood that within the scope of the appended claims, the invention may be practiced otherwise than as specifically described herein.

1. An imaging device comprising:
an imaging element having a light acceptance plane;
a circuit board for the imaging element;
a frame member configured to support the imaging element; and
a supporting member configured to support an image formation lens,
wherein said frame member surrounds and fixedly supports said imaging element so that an imaging element plane on a side of said light acceptance plane and a reference plane of said frame member are located on a same plane or have a predetermined difference in relative distance, and the reference plane of said frame member and the reference plane of said supporting member are brought into contact with each other to be integrated.

2. The imaging device according to claim 1,
wherein the supporting member comprises a lens holder configured to fixedly support said image formation lens and a supporter configured to support said lens holder, and
wherein said lens holder is positioned and held on said supporter.

3. The imaging device according to claim 1,
wherein the supporting member comprises a lens holder configured to fixedly support said image formation lens and a supporter configured to fit said lens holder, and
wherein said lens holder is fitted to said supporter so that said image formation lens is located at a predetermined focal distance with respect to the light acceptance plane of the imaging element at a position the lens holder is fully fitted to the supporter.

4. The imaging device according to claim 1,
wherein the supporting member comprises a lens holder configured to fixedly support said image formation lens and a supporter configured to screw-engage with said lens holder at a screw-threaded portion, and
wherein by adjusting said screw-threaded portion, a focus of said image formation lens can be adjusted with respect to the light acceptance plane of the imaging element.

5. The imaging device according to claim 1,
wherein said frame member surrounds said imaging element so that an imaging element plane on the side of the light acceptance plane and the reference plane of the frame member are located on the same plane or have the predetermined difference in relative distance, and
wherein the imaging element is glued to said frame member on the side of the imaging element opposite to the light acceptance plane.

6. The imaging device according to claim 1,
wherein the frame member is thicker than the imaging element.

7. The imaging device according to claim 5,
wherein the frame member is thicker than the imaging element, and
wherein said imaging element and the frame member surrounding the imaging element are fixedly glued at a level difference portion therebetween.

8. An imaging device comprising:
an imaging element having a light acceptance plane;
a circuit board for the imaging element;
a frame member configured to support the imaging element; and
a supporting member configured to support an image formation lens,
wherein said frame member surrounds and fixedly supports said imaging element so that an imaging element plane on a side of said light acceptance plane and a reference plane of said frame member are located on a same plane or have a predetermined difference in relative distance,
wherein a wall portion is provided around the reference plane of said frame member to form a cavity, and
wherein the reference plane of said frame member and the reference plane of said supporting member are brought into contact with each other within said cavity so as to be integrated.

9. The imaging device according to claim 8,
wherein the reference plane of said frame member and the reference plane of
said supporting member are brought into contact with each other within said
cavity and sealed at a level difference portion between said wall portion and
said supporting member.

10. A manufacturing method of an imaging device, comprising the steps of:
arranging an imaging element plane on a side of a light acceptance plane in contact with a reference plane of a stage;
arranging a reference plane of a frame member surrounding said imaging element and in contact with the reference plane of said stage;
holding the imaging element plane on a side of said light acceptance plane and the reference plane of said frame member on a same plane so as to integrate the imaging element and the frame member via an adhesive; and
maintaining a contact between the reference plane of said frame member and a reference plane of a supporting member supporting an image formation lens so as to integrate the frame member and the supporting member via an adhesive.

11. The manufacturing method according to claim 10, wherein, on the reference plane of the stage, a portion of the imaging element facing the light acceptance plane is formed into a recess in such a manner that said light acceptance plane and the reference plane of said stage are not in contact with each other.

12. The manufacturing method according to claim 10, wherein said imaging element and said frame member are integrated using the adhesive by arranging said imaging element plane on the side of the light acceptance plane in contact with the reference plane of the stage, by arranging the reference plane of said frame member surrounding said imaging element and in contact with the reference plane of the stage, and by holding the imaging element plane on the side of the light acceptance plane and the reference plane of the frame member on the same plane by applying a load thereto.

13. The manufacturing method according to claim 10, wherein said imaging element and said frame member are integrated using the adhesive by arranging said imaging element plane on the side of the light acceptance plane in contact with the reference plane of the stage, by arranging the reference plane of said frame member surrounding said imaging element and in contact with the reference plane of said stage, and by holding the imaging element plane on the side of said light acceptance plane and the reference plane of said frame member on the same plane by vacuum suction.

14. A manufacturing method of an imaging device, comprising the steps of:
arranging an imaging element plane on a side of a light acceptance plane in contact with a first reference plane of a stage;
arranging a reference plane of said frame member surrounding said imaging element and in contact with a second reference plane of said stage;
holding the imaging element plane on a side of said light acceptance plane and the reference plane of said frame member to have a predetermined difference in relative distance therebetween so as to integrate the imaging element and the frame member via an adhesive; and
maintaining a contact between the reference plane of said frame member and a reference plane of the supporting member supporting an image formation lens so as to integrate said frame member and a supporting member via an adhesive.

15. An imaging system comprising:
an imaging element having a light acceptance plane;
circuit means for the imaging element;
frame means for supporting the imaging element; and
supporting means for supporting an image formation lens,
wherein said frame means surrounds and fixedly supports said imaging element so that an imaging element plane on a side of said light acceptance plane and a reference plane of said frame means are located on a same plane or have a predetermined difference in relative distance, and the reference plane of said frame means and the reference plane of said supporting means are brought into contact with each other to be integrated.

16. The imaging system according to claim 15,
wherein the supporting means comprises lens holder means for fixedly supporting said image formation lens and supporter means for supporting said lens holder means, and
wherein said lens holder means is positioned and held on said supporter means.

17. The imaging system according to claim 15,
wherein the supporting means comprises a lens holder means for fixedly supporting said image formation lens and supporter means for fitting said lens holder means, and
wherein said lens holder means is fitted to said supporter means so that said image formation lens is located at a predetermined focal distance with respect to the light acceptance plane of the imaging element at a position the lens holder means is fully fitted to the supporter means.

18. The imaging system according to claim 15,
wherein the supporting means comprises lens holder means for fixedly supporting said image formation lens and supporter means for screw-engaging with said lens holder means at a screw-threaded portion, and
wherein by adjusting said screw-threaded portion, a focus of said image formation lens can be adjusted with respect to the light acceptance plane of the imaging element.

19. The imaging system according to claim 15,
wherein said frame means surrounds said imaging element so that an imaging element plane on the side of the light acceptance plane and the reference plane of the frame means are located on the same plane or have the predetermined difference in relative distance, and
wherein the imaging element is glued to said frame means on the side of the imaging element opposite to the light acceptance plane.

20. The imaging device according to claim 15,
wherein the frame means is thicker than the imaging element.
